(19) United States
(12) Patent Application Publication
(10) Pub. No.: US 2006/0059489 A1
(43) Pub. Date: Mar. 16, 2006

(54) Parallel processing system, interconnection network, node and network control method, and program therefor

(75) Inventor: Hisao Koyanagi, Tokyo (JP)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 11/227,107

(22) Filed: Sep. 16, 2005

(30) Foreign Application Priority Data
Sep. 16, 2004 (JP) 2004-269495

(51) Int. Cl. G06F 9/46

(52) U.S. Cl. 718/100

(57) ABSTRACT

The parallel processing system includes a plurality of nodes which are interconnected over an interconnection network; wherein the parallel processing system divides a computer job into parallel jobs by a parent process performed by a computer arranged in the nodes, and the parallel jobs are processed by the plurality of child processes using the plurality of computers arranged in the plurality of nodes; and a transfer process through the interconnection network from a slow child process in the child processes is performed on a basis of priority over other transfer processes.

### BACKGROUND OF THE INVENTION

1. Field of the Invention

The present invention relates to a parallel processing system, and more specifically to a parallel processing system, an interconnection network, a node and network control method for shortening the turnaround time (TAT) of the entire parallel job and enhancing the efficiency of the entire system, and a program for them.

2. Description of the Related Art

A parallel job is a method of shortening the turnaround time (TAT) by a parent process dividing a series of jobs to a plurality of child processes. In this method, processes are divided by a parallel compiler such that the processes can be simultaneously completed with load balance taken into account. However, when a parallel operation is practically performed, disturbance form other jobs, asynchronous communications among child processes, etc. cause a problem of load imbalance. That is, the variance of run time causes the TAT of the most time-consuming child process to rate-determine the TAT of the entire parallel job.

The load imbalance not only has a bad influence on the parallel job TAT, but also causes the problem that computation resources cannot be effectively utilized. For example, there is the problem that the insignificant polling process for waiting for the termination of the last child process has to be continued by a parent process.

The above-mentioned problems cannot be successfully solved only by system software such as the parallel compiler, the job scheduler, etc. That is, load imbalance occurs for the above-mentioned reasons however evenly a compiler, etc. divides the load of a task. Furthermore, although synchronous control for post-wait method is performed to facilitate the performance of a job scheduler, that is, an effective use of arithmetic operation resources is expected by placing a waiting process in a sleep state without waiting in a polling state and resuming it by an interrupt when synchronization can be established, the overhead of the interrupt processing can disturb an expected effect.

Examples of methods for solving the problems are described in, for example, Japanese Patent Application Publication No. 6-149752 (hereinafter referred to as a patent document 1), and, for example, Japanese Patent Application Publication No. 2000-231502 (hereinafter referred to as a patent document 2).

The method of the patent document 1 relates to a barrier synchronous system for enhancing the system throughput in a system having a plurality of processors and main memory connected over a network.

In the method of the patent document 1, the number of processors (variable) is stored in main memory. The number of processors first refers to the current number of processors, and when each processor completes each process, each processor issues an instruction to the main memory to subtract 1 from the number of processors. When the processors complete the respective processes, the number of processors decreases, and reaches 0 when all processors complete the respective processes. When the number of processors reaches 0, each processor starts the next process, thereby attaining the barrier synchronization.

The method disclosed by the patent document 1 is to perform a coherence operation only when the barrier synchronization is attained. In this method, as compared with the method used before the method of the patent document 1 with the coherence operation performed when each processor completes its process, the throughput can be much more enhanced on the entire system for performing the coherence operation with the high-speed and minimal value.

The method disclosed by the patent document 2 relates to a delay factor analyzing method in a system using a management computer and a plurality of computers connected over a network.

In the method of the patent document 2, the history information about the history of the execution of a job is transmitted from each computer to a management computer. When it is detected that the scheduled ending time of the computer system is behind longer than a predetermined time, the execution time is compared with the scheduled execution time in the last job. If the execution time is longer than the scheduled execution time, it is determined that the factor of the delay resides in the computer that executes the last executed job.

When the execution time is shorter than the scheduled execution time, it is checked whether or not the execution starting time has passed the scheduled starting time, and it is analyzed whether the factor of the delay resides in the job or in the performance of the computer.

According to the patent document 2, the factor of the delay of the job processing can be attributed separately to a job and a computer.

The above-mentioned conventional technologies have the following problems respectively.

In the patent document 1, the system throughput can be enhanced by setting the coherence operation to the high-speed and minimal value in the system provided with a plurality of processors and main memory connected over a network.

However, the method of the patent document 1 does not solve the problem of the load imbalance. That is, in the method of the patent document 1, barrier synchronization is attained after waiting for the completion of the processes of all processors, but the TAT of all parallel jobs is not shortened.

In the method of the patent document 2, when the ending time of a computer system is longer than a predetermined time behind a scheduled ending time in a system configured by a management computer and a plurality of computers connected over a network, the factor of a delay can be extracted separately from a job and a computer.

However, the method of the patent document 2 can extract the factor of a delay separately from a job and a computer, but the TAT of the entire parallel job is not shortened as in the method of the patent document 1.

### SUMMARY OF THE INVENTION

The exemplary feature of the present invention is to solve the problems with the above-mentioned conventional technologies, and to provide a parallel processing system, an interconnection network, anode and network control method, and a program therefor that can divide a computer job, shorten the TAT of the entire parallel job for performing parallel processing among a plurality of child processes, and enhance the system efficiency.

The parallel processing system according to the present invention includes a plurality of nodes which are interconnected over an interconnection network; wherein the parallel processing system divides a computer job into parallel jobs by a parent process performed by a computer arranged in the nodes, and the parallel jobs are processed by the plurality of child processes using the plurality of computers arranged in the plurality of nodes; and a transfer process through the interconnection network from a slow child process in the child processes is performed on a basis of priority over other transfer processes.

The network control method according to the present invention is used over an interconnection network, wherein:

the interconnection network is connected to a node in which a computer performing a parent process which divides a computer job into parallel jobs is arranged, and a plurality of nodes in which a computer performing a plurality of child processes performing the parallel jobs is arranged; and

the control method comprises processing a transfer process from a slow child process in the child processes on a priority basis over other transfer processes.

A computer-readable storage medium recording thereon a program according to the present invention causes a computer to perform said the steps of above network control method.

Exemplary advantage of the invention is to divide a computer job, shorten the TAT of the entire parallel job for performing parallel processing in a plurality of child processes, thereby enhancing the system efficiency.

The above-mentioned advantage can be realized by successfully shortening the TAT of the child process slow in processing in all child processes in the parallel job by first processing the transfer process of the slowest child process on a priority basis.

### BRIEF DESCRIPTION OF THE DRAWINGS

The above and other objects, features and advantages of the present invention will become apparent from the following detailed description when taken with the accompanying drawings in which:

FIG. 1 is a block diagram of the configuration of the parallel processing system according to an embodiment of the present invention;

FIG. 2 shows the configuration of the child process number replication circuit according to an embodiment of the present invention;

FIG. 3 is an explanatory view of the comparison between the barrier synchronization according to an embodiment of the present invention and the barrier synchronization according to a conventional technology;

FIG. 4 is an explanatory flowchart of the general operation of the parallel processing system according to an embodiment of the present invention;

FIG. 5 is an explanatory flowchart of the operation of the IN according to an embodiment of the present invention;

FIG. 6 is an explanatory view of executing a parallel job by child processes according to an embodiment of the present invention;

FIG. 7 is an explanatory view of the flow of the process of the parallel job according to an embodiment of the present invention;

FIG. 8 shows the operation of the child process according to an embodiment of the present invention;

FIG. 9 shows the configuration of the request arbitration circuit according to an embodiment of the present invention;

FIG. 10 shows the configuration of the child process number monitor circuit according to an embodiment of the present invention;

FIG. 11 is an explanatory view of the execution of the parallel job by child processes according to the conventional technology; and

FIG. 12 is an explanatory view of the flow of the process of the parallel job according to the conventional technology.

### DETAILED DESCRIPTION OF THE EXEMPLARY EMBODIMENT

The preferred embodiments of the present invention are explained below in detail by referring to the attached drawings.

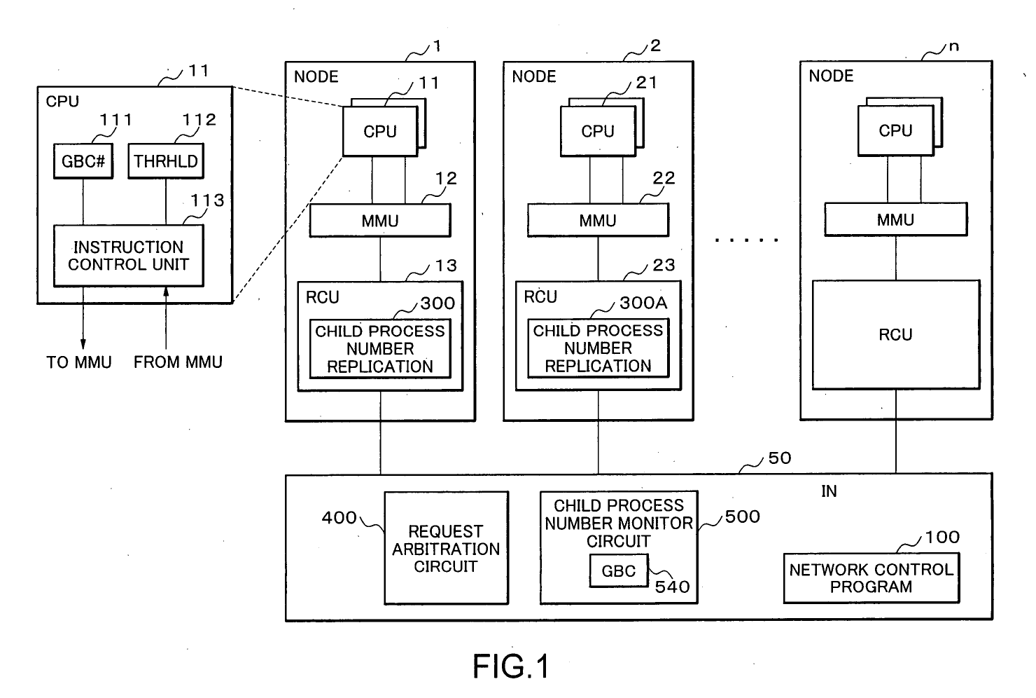

FIG. 1 is a block diagram of the configuration of the parallel processing system according to an embodiment of the present invention,

The parallel processing system according to an embodiment of the present invention includes a plurality of nodes 1, 2, . . . and n, an interconnection network (hereinafter referred to as an IN) 50. Each of the plurality of nodes 1, 2, . . . and n has the same structure. Unless otherwise specified, the node 1 is explained below. Other nodes are similar to the node 1.

In FIG. 1, the node 1 according to the present embodiment comprises one or more central processing unit (CPU) 11, a main memory unit (MMU) 12, and a remote node control unit (RCU) 13.

The MMU 12 can store data for transfer between nodes.

Upon receipt of a notification of inter-node data transfer request from the CPU 11, the RCU 13 reads the data to be transferred from the MMU 12, and transfers it to the IN 50.

The IN 50 according to the present embodiment receives a data transfer request from a plurality of nodes, and can transfer data between the nodes.

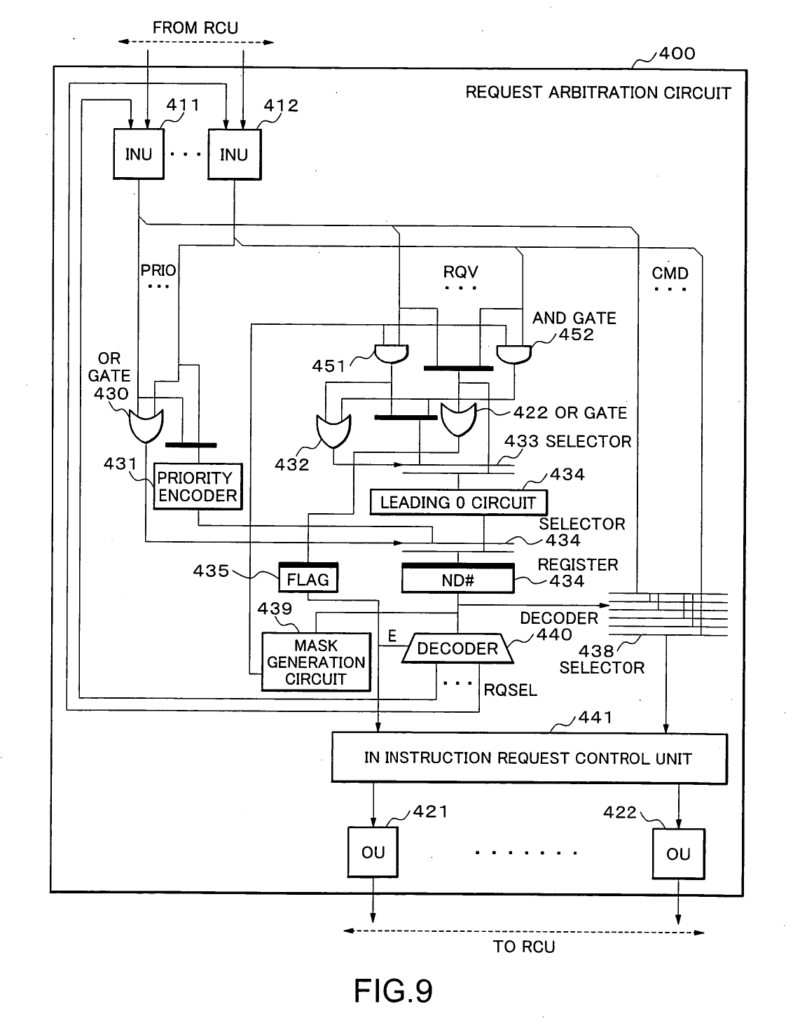

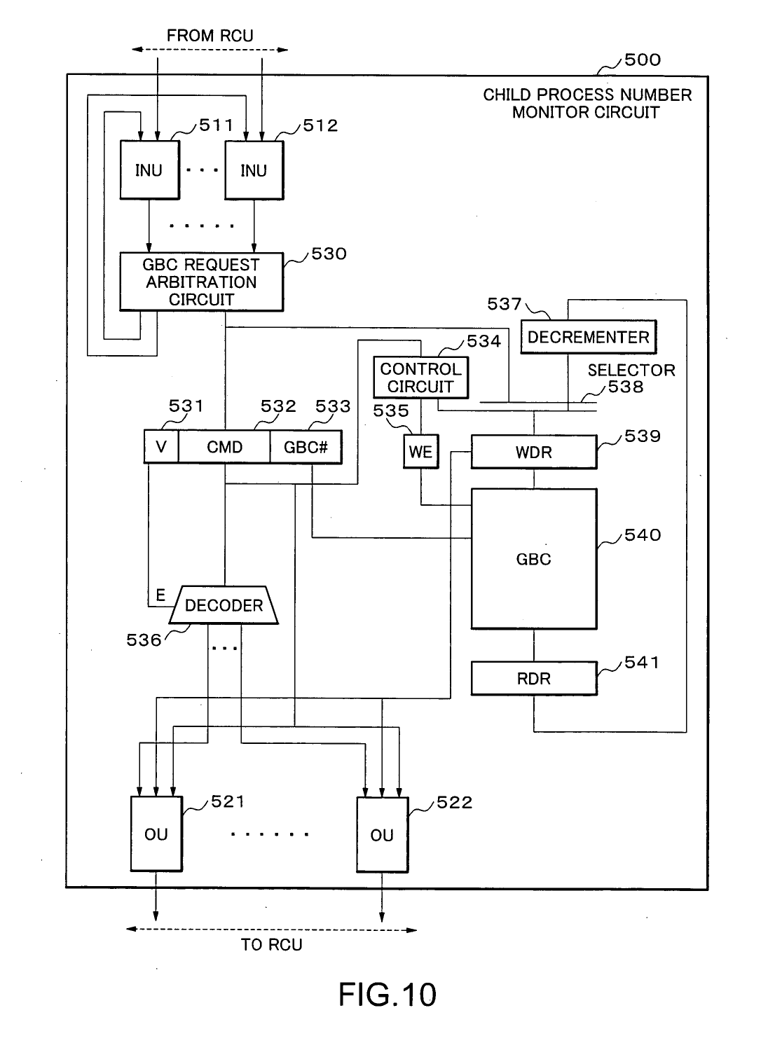

The IN 50 is provided with a request arbitration circuit 400 and a child process number monitor circuit 500. The child process number monitor circuit 500 is provided with a Global Barrier synchronous Counter (hereinafter referred to as a GBC) 540. The details of the request arbitration circuit 400 and the child process number monitor circuit 500 are described in explaining FIGS. 9 and 10.

In this embodiment, the GBC 540 as a register group which holds the number of child processes of a parallel job is explained. The parallel processing system according to the present embodiment is based on the operation of a plurality of parent processes.

The GBC 540 is a register group which holds a plurality of numbers of child processes for synchronization. The plural numbers of child processes correspond to the respective parent processes. The plural numbers of child processes corresponding to the plurality of parent processes are held in the registers of different GBC# in the GBC 540.

A GBC# is an address of the register corresponding to each parent process in the GBC 540, and can be used in identifying a parent process. A computer can issue a process number for use in identifying a parent process.

When a GBC value is accessed from each node, a GBC# is specified to access the number of child processes of a parallel job relating to the node by specifying the GBC#.

In the description below, the value stored in each register of the GBC 540 as a register group is hereinafter referred to as a GBC value, the value stored in the register of a GBC# 111 described later as a GBC# value, and the value stored in the register of a Thrhld (threshold) 112 as a Thrhld value.

In this case, the GBC value indicates the number of child processes, the GBC# indicates an address, and the Thrhld value indicates the set value of priority.

Each node first performs a Save Global Barrier synchronous Counter Flag (hereinafter referred to as SGBCF) (also referred to as an INIT (initialization) instruction) to write a necessary number of child processes for barrier synchronization to the GBC value of the GBC 540 in the case of the parent process.

The child process of each node performs a given process, executes the SGBCF instruction (dec (short for decrement)) when the process is performed, and decrements the GBC value held in the GBC 540 by 1.

The GBC# 111 set in the CPU 11 is a register for holding the register address of the GBC 540 as a register group. The parent process of a parallel job can be identified by a GBC# value.

The Thrhld 112 is a register for holding for each process a value to attain the best possible effect of the value control of process priority. The Thrhld 112 holds a value for setting a priority, and when the value is equal to or larger than the GBC value, a priority can be set.

For example, when the GBC value is 1, a priority can be set for a Thrhld value of 1 or more.

When the GBC value is 1, that is, when only the slowest child process is operating, and the process is to have a priority, the parent process can set all 1 to the Thrhld values of all child processes when activation is performed by the inter-processor communication (hereinafter referred to as a P communication).

An instruction control unit 113 performs an operation of holding the values of the GBC# 111 and the Thrhld 112 for each process.

When a transmit instruction to the IN 50 is issued to the MMU 12, the instruction control unit 113 can issue it with the values held in the GBC# 111 and the Thrhld 112.

The instruction to be transmitted to the IN 50 can be referred to as an IN related instruction for short.

A child process number replication circuit 300 is provided in the RCU 13. The child process number replication circuit 300 copies and holds the value of the number of child processes held in the GBC 540 of the child process number monitor circuit 500. The child process number replication circuit 300 is explained below.

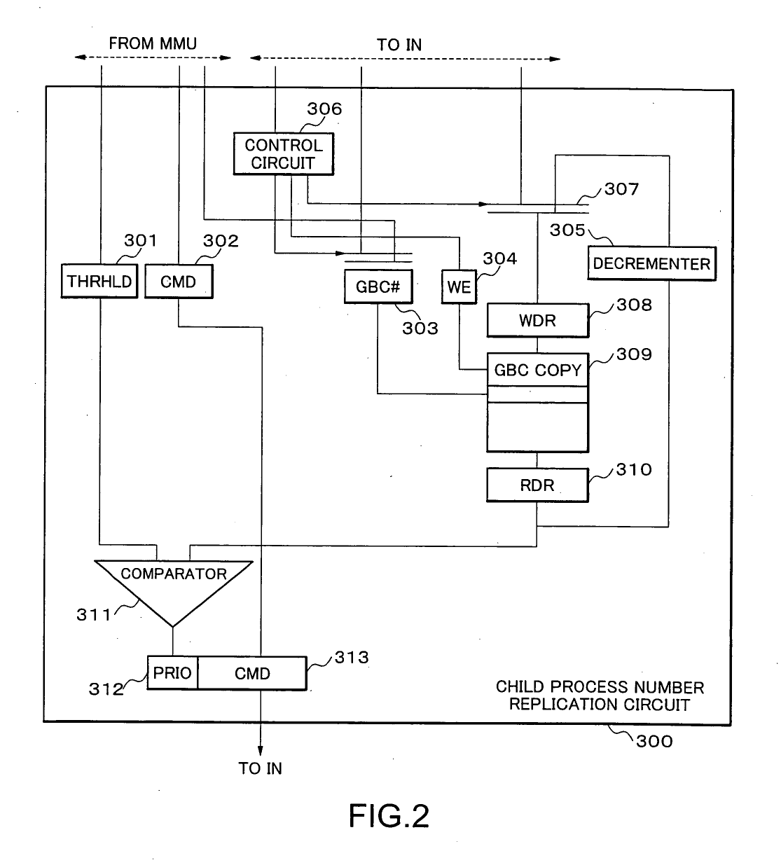

FIG. 2 shows the configuration of the child process number replication circuit 300 according to an embodiment of the present invention.

A Thrhld 301 is a register for holding a Thrhld value assigned to an IN 50 related instruction request transmitted from the MMU 12.

A command register (hereinafter referred to as a CMD) 302 is a register for holding an instruction command assigned to an IN related instruction request transmitted from the MMU 12. A command value indicates type information about an instruction.

A CMD 313 is a register for holding an instruction command of the CMD 302, and the value is transmitted to the IN 50.

A GBC# 303 is a register for holding a GBC# value assigned to an IN related instruction request transmitted from the MMU 12 or a GBC# value associated with a request transmitted from the IN 50.

A GBC copy 309 is a register for copying and holding the GBC value of the parent process related to a node held by the GBC 540.

A write enable (hereinafter referred to as a WE) 304 is a register for holding a write enable signal (WE) of the GBC copy 309.

A decrementer 305 decrements (subtracts 1 from) the GBC value held in the GBC copy 309.

A control circuit 306 accepts a rewrite request of the GBC value from the IN 50 to each node, and controls a rewrite of the contents of the GBC copy 309.

A selector 307 can switch the GBC value of a rewrite request of the GBC value from the IN 50 and the GBC value of the decrementer 305.

A write data register (hereinafter referred to as a WDR) 308 is a register for holding data to be written to the GBC copy register 309.

The RDR 310 is a register for holding data read from the GBC copy 309.

A comparator 311 compares the data of the read data register (hereinafter referred to as a RDR) 310 with the data of the Thrhld 301, and activates the output signal when the data value of the Thrhld 301 is equal to or larger than the data value of the RDR 310, thereby adding the priority.

A Prio 312 is a register for holding the output of the comparator 311, and the value is transmitted to the IN 50.

An IN related instruction is transmitted to the IN 50 from the CPU 11 through the MMU 12 and the RCU 13. At this time, a Thrhld value, a command value, and a GBC# assigned by the CPU 11 are stored respectively in the Thrhld 301, the CMD 302, and the GBC# 303.

The child process number replication circuit 300 is set in the RCU 13 of the node 1, but can also be outside the RCU 13 in the node.

The operation according to the present embodiment is explained below in detail by referring to the attached drawings. To more clearly explain the characteristics of the present invention, the operation of the barrier synchronization by the conventional technology is first described below.

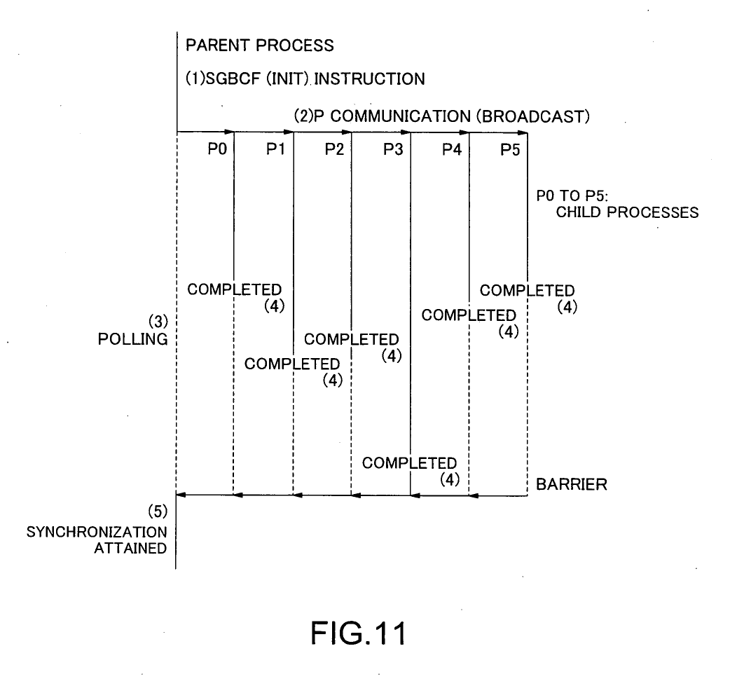

FIG. 11 is an explanatory view of the execution of the parallel job of a child process according to the conventional technology.

When a job is divided by a parent process into six child processes, and the parent process knows the completion of the divided child processes by the barrier synchronization, the parallel job is terminated. To explain the progress of the process, a number enclosed by parentheses is given in an execution order. In the following explanation, the number enclosed by the parentheses is shown at the corresponding portion in the sentences.

By referring to FIG. 11, (1) an SGBCF (Init) instruction is executed in the node of the parent process, and the number of child processes required for barrier synchronization is written to the GBC 540.

Next, the parent process (2) establishes inter-processor communication (hereinafter referred to as P communication by a broadcast), and issues a directive to activate a child process of each node. Then, to monitor a synchronous status, (3) it starts polling.

On the other hand, a child process of each node executes a process given to each child process, and (4) when the process is completed, an SGBCF (dec) instruction is executed by a broadcast, and a GBC value held in the IN 50 is decremented by 1.

When the instruction is executed for the IN 50, and the GBC value stored in the GBC 540 of the IN 50 is 0, (5) the barrier synchronization of the child process is completed.

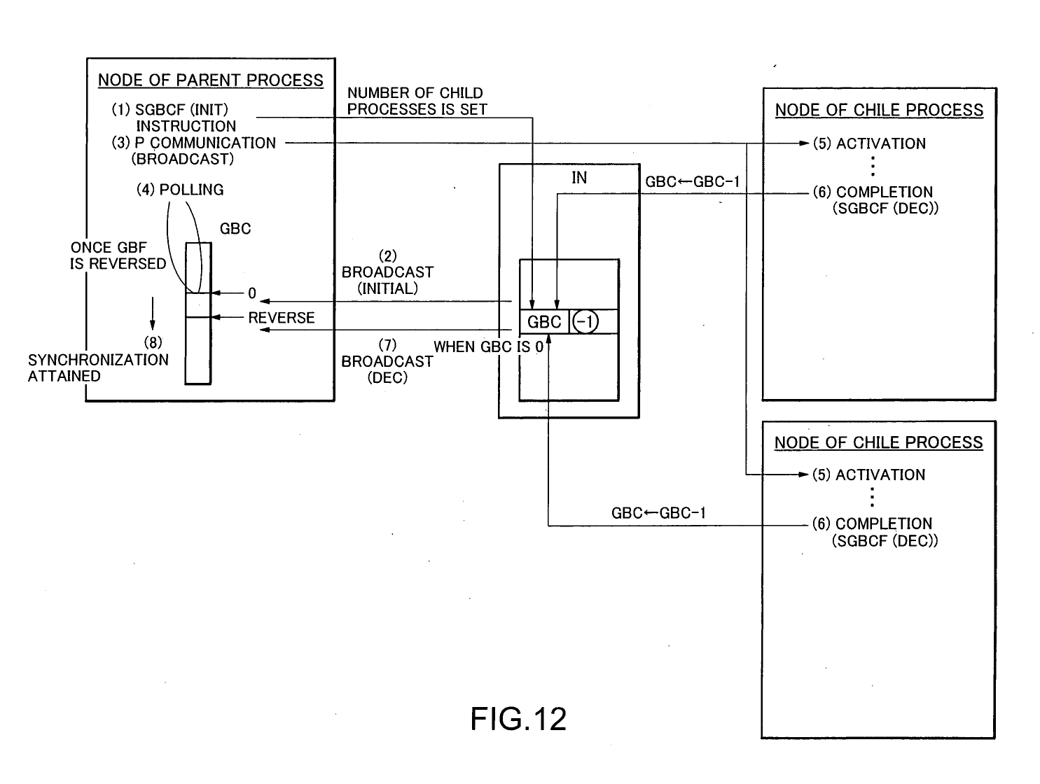

FIG. 12 is an explanatory view of the flow of the process of the parallel job according to the conventional technology. In the conventional technology, since the configuration of the parallel processing system is the same as the configuration according to the present embodiment, the explanation is given below by referring to the important portion shown in FIG. 1.

To explain the progress of the process in each node, a number enclosed by parentheses is given in an execution order. In the following explanation, the number enclosed by the parentheses is shown at the corresponding portion in the sentences.

In FIG. 12, (1) the SGBCF (Init) instruction is first executed, and the number of child processes required for the barrier synchronization is written to the GBC 540 in the IN 50.

Next, (2) the IN 50 instructs a node of the parent process to initialize a Global Barrier synchronous Flag (hereinafter referred to as a GBF). The GBF is a flag indicating whether or not a parallel job by a child process is being executed.

Then, the parent process further (3) issues a directive to activate a child process of each node by inter-processor communication (hereinafter referred to as P communication) (broadcast).

Then, to monitor the synchronous status, (4) polling is started.

On the other hand, the child process of each node is (5) activated, and then the process given in each child process is performed. When it is completed, (6) the SGBCF (decrement (hereinafter referred to as dec for short) instruction is executed, and the GBC value held in the IN 50 is decreased by 1.

When the instruction is executed for the IN 50, and the accumulated value of the SGBCF (dec) instruction becomes equal to the number of child processes, the GBC value stored in the GBC 540 of the IN 50 is 0. At this time, the barrier synchronization of the child process is attained. Then, (7) the IN 50 performs a broadcast (DEC) for inverting the GBF of a parent node.

Since the parent process (8) monitors the status of the GBF by polling, it recognizes the timing of the completion of synchronization.

Explained below is the difference in barrier synchronization between the conventional technology and the present embodiment.

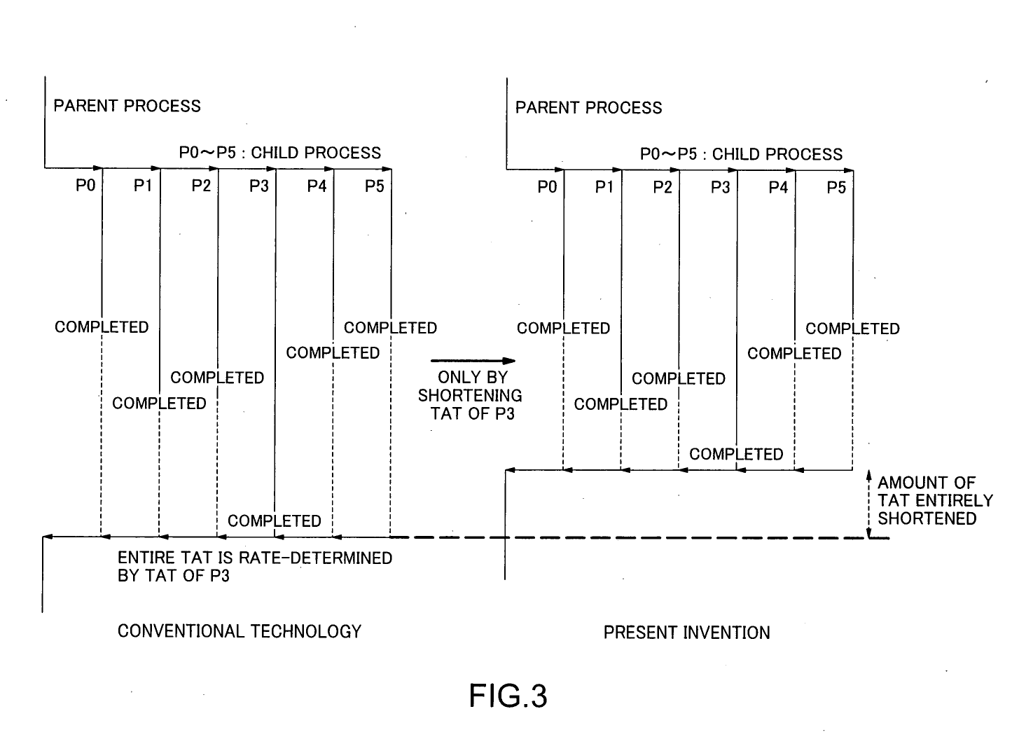

FIG. 3 is an explanatory view of the comparison between the barrier synchronization according to the present embodiment and the barrier synchronization according to the conventional technology.

By referring to FIG. 3, the conventional technology divides a process into 6 child processes P0 to P5 as parallel processes. Assume that the process P3 takes the longest time. In this case, since the parent process continues waiting the end of the process P3, the entire TAT is rate-determined based on the slowest process P3.

In the present embodiment, the TAT of the P3 is shortened on a priority basis. Therefore, the TAT of the parallel job is shortened correspondingly, thereby enhancing the efficiency of the entire system.

Then, prior to the explanation of the barrier synchronization according to the present embodiment, the general operation of the parallel processing system and the operation of the IN 50 according to the present embodiment are described below.

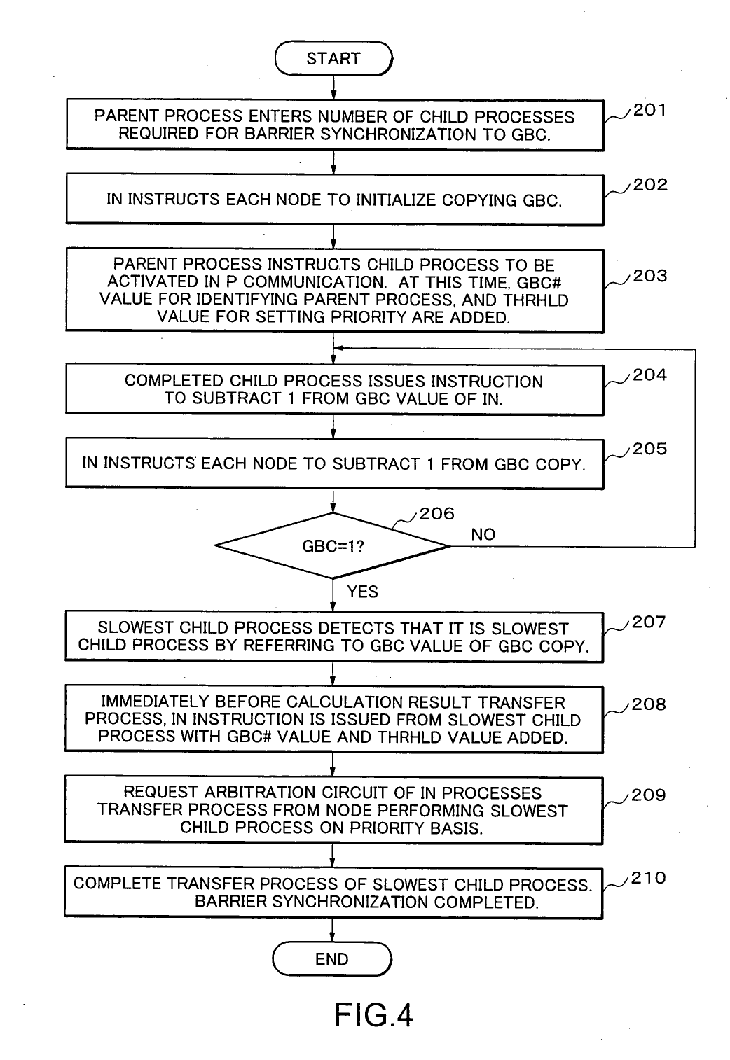

FIG. 4 is a flowchart for explanation of the general operation of the parallel processing system according to an embodiment of the present invention.

First, a parent process enters the number of child processes required for barrier synchronization in the GBC 540 (step 201).

Then, an instruction to initialize the GBC copy 309 is issued from the IN 50 to each node. By the initialization, the number of child processes required for the barrier synchronization is written to the GBC copy 309 (step 202).

Next, the parent process issues an instruction to activate a child process in P communication. At this time, the GBC# value for the identification of a parent process and a Thrhld value for setting a priority are added (step 203).

An instruction to subtract 1 from the GBC value of the IN 50 from the terminated child process in the activated child processes is issued (step 204).

Upon receipt of the instruction to subtract 1 from the GBC value, the IN 50 instructs each node to subtract 1 from the GBC copy value (step S205).

When the GBC value is larger than 1, a plurality of child processes are operating. Therefore, control is returned to step 204 (step 206).

When the value of the GBC 540 is equal to 1, only the slowest child process is operating. Therefore, control is passed to the next step (step S206).

The slowest child process detects that it is the slowest child process by referring to the GBC value of the GBC copy 309 (step 207).

The child process recognized that it is the slowest process issues an IN instruction immediately before the calculation result transfer process. At this time, the GBC# value, and the Thrhld value are added (step 208).

Upon receipt of an IN instruction to set a priority from a child process, the request arbitration circuit 400 of the IN 50 processes on a priority basis the transfer process from a node in which the slowest child process is being processed (step 209).

When the transfer process on the slowest child process is completed, the barrier synchronization terminates (step 210).

Described above is the general operation of the parallel processing system according to an embodiment of the present invention.

The general operation of the IN 50 for transferring data in the parallel processing system according to an embodiment of the present invention is explained.

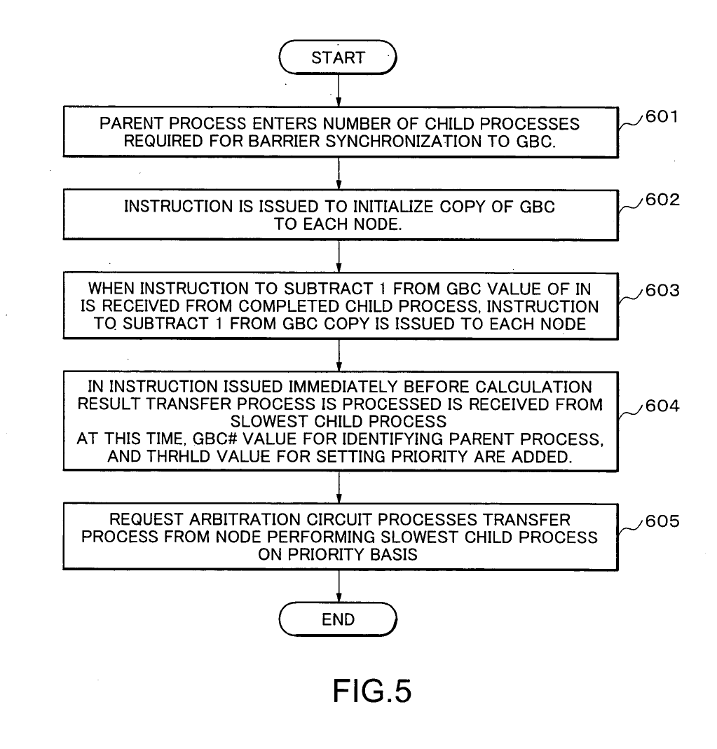

FIG. 5 is a flowchart for explanation of the operation of the IN 50 according to an embodiment of the present invention.

First, a parent process enters the number of child processes required for barrier synchronization in the GBC 540 (step 601).

Next, an instruction to initialize the GBC copy 309 is issued to each node. By the initialization, the number of child processes required for barrier synchronization is written to the GBC copy 309 (step 602).

Next, the parent process issues an instruction to activate the child process in the P communication, and a parallel job is started. When a part of child processes is completed, an instruction to subtract 1 from the GBC value is issued by the child process.

Upon receipt of an instruction to subtract 1 from the GBC value from the terminated child process, the GBC value is rewritten, and an instruction to subtract 1 from the GBC copy value is issued to each node (step 603).

When the GBC value is decreased and becomes equal to 1, the slowest child process is detected as the slowest child process.

The IN 50 receives an IN instruction immediately before a calculation result transfer process from the child process which recognizes that it is the slowest process. At this time, the GBC# value for identification of a parent process, and the Thrhld value for setting a priority are added (step 604).

Upon receipt of an IN instruction for setting a priority from a child process, the request arbitration circuit 400 processes a transfer process from a node in which the slowest child process is being processed on a priority basis (step 605).

When the transfer process of the slowest child process is completed, the barrier synchronization terminates.

Explained above are the general operation of the parallel processing system and the general operation of the IN 50 for transferring data in the parallel processing system according to an embodiment of the present invention.

Next, the operation of the barrier synchronization according to an embodiment of the present invention is explained below.

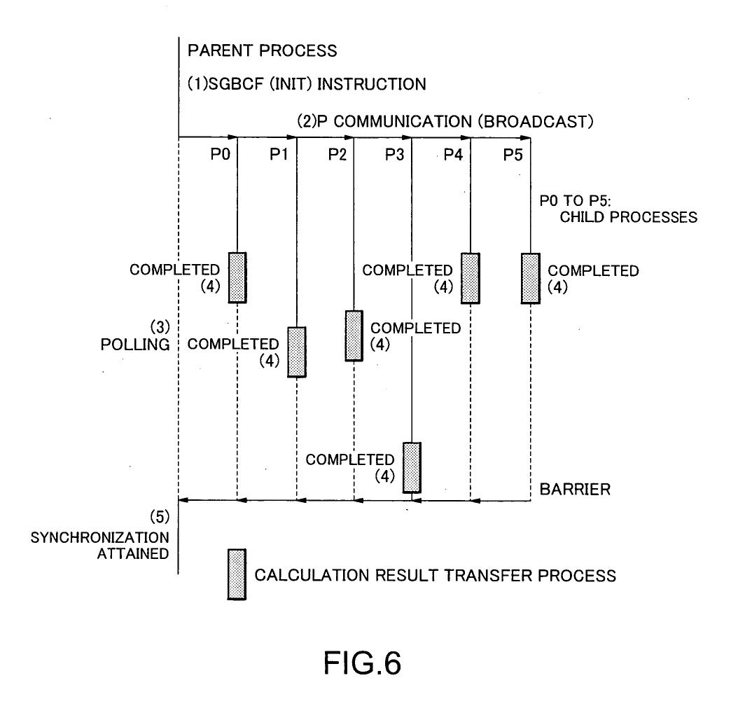

FIG. 6 is an explanatory view of the execution of a parallel job in a child process according to an embodiment of the present invention.

In FIG. 6, a process is divided by a parent process into six child processes, and the completion of the child processes is announced to the parent process by barrier synchronization, thereby terminating the parallel job.

The flow of the execution of the parallel job matches the flow of the execution of a parallel job in a child process in the conventional technology shown in FIG. 11. However, in the embodiment of the present invention, a calculation result transfer process is performed before the completion of a child process.

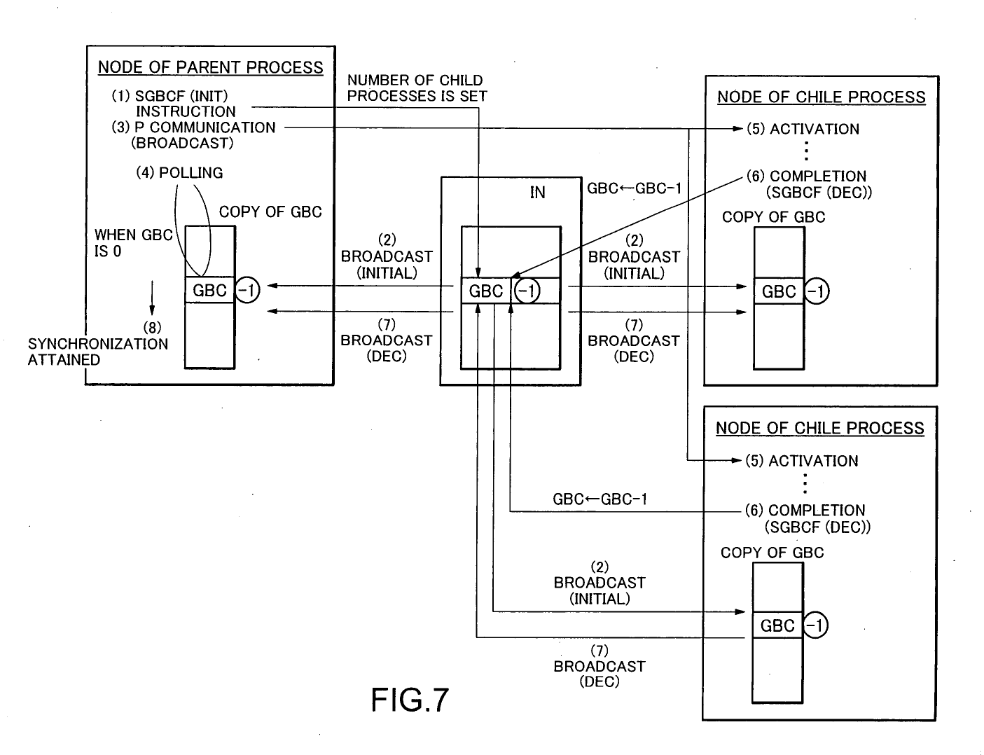

FIG. 7 is an explanatory view of the flow of the process of a parallel job according to an embodiment of the present invention.

To explain the progress of the process in each node, a number enclosed by parentheses is given in an execution order. In the following explanation, the number enclosed by the parentheses is shown at the corresponding portion in the sentences.

In FIG. 7, first, (1) a parent process executes the SGBCF (Init) instruction in the node of the parent process, and the parent process writes the number of child processes required for barrier synchronization to the GBC value of the GBC 540.

Then, (2) when the IN 50 recognizes that the number of child processes is written to the GBC 540, it broadcasts to each node the process of initializing the copy of GBC. By the broadcast, the number of child processes is written to the GBC copy 309 of the child process number replication circuit 300 of each node.

Next, the parent process (3) issues an instruction to activate the child process of each node in the P communication.

Then, to monitor the status of the completion of barrier synchronization, (4) polling is started.

On the other hand, (5) each child process performs a given process after being activated. When the process is completed, (6) it executes the SGBCF (dec) instruction, and subtracts one by one from the GBC value held in the IN 50.

Upon receipt of the instruction, (7) the IN 50 broadcasts the DEC request of the GBC copy to each node (request to subtract 1 from the GBC copy value). In this process, the GBC copy values are guaranteed to match among the nodes.

When the instruction is executed on the IN 50 at the frequency equal to the number of child processes, the GBC value of the GBC 540 becomes 0. In this state, (8) the barrier synchronization of the child processes is completed.

In the present embodiment, the GBC value has a copy in each node. Therefore, unlike the conventional technology shown in FIG. 12, it is not necessary to broadcast the completion of barrier synchronization from the IN 50.

The node of the parent process can recognize that the synchronization has been completed since the state of the GBC copy 309 is monitored by polling.

When each child process terminates an assigned calculation process, it performs an inter-node data transfer to return the calculation result to the parent process. Upon receipt of the data, the parent process aggregates the results of the entire parallel job.

In the present embodiment, by realizing the enhancement of the performance in the last inter-node data transfer by the slowest child process, the TAT of the entire parallel job can be shortened.

As explained above, the system according to the present invention is a parallel processing system having a plurality of nodes 1 and 2 interconnected through the IN 50. With the configuration, a parent process executed by a computer provided in a node divides a computer job into parallel jobs, and the parallel jobs are processed in parallel by a plurality of child processes using a plurality of computers arranged in a plurality of nodes. A transfer process from the slowest child process in all child processes is performed on a priority basis over other transfer processes in an interconnection network.

The process performed by a plurality of child processes is configured by a calculation process and a calculation result transfer process, and the calculation result transfer process is performed after performing the calculation process. Therefore, the transfer process from a child process performed on a priority basis is a calculation result transfer process.

Other transfer processes are not those from the plurality of child processes, but those performed between another parent process and its child processes for the following reason.

When a priority is assigned to the slowest child process, child processes divided by the parent process of the slowest child process are completed except the slowest child process. Therefore, if a priority is assigned to the slowest child process, the transfer process of the child process is performed on a priority basis over the transfer processes performed between another parent process and its child processes.

In FIG. 6, the slowest child process is P3. When the process P1, that is, the second slowest process after P3, is completed, the copy GBC value of each node is 1. Therefore, as described below, the child process P3 recognizes that it is the slowest process.

Described below in detail is the operation of the slowest child process.

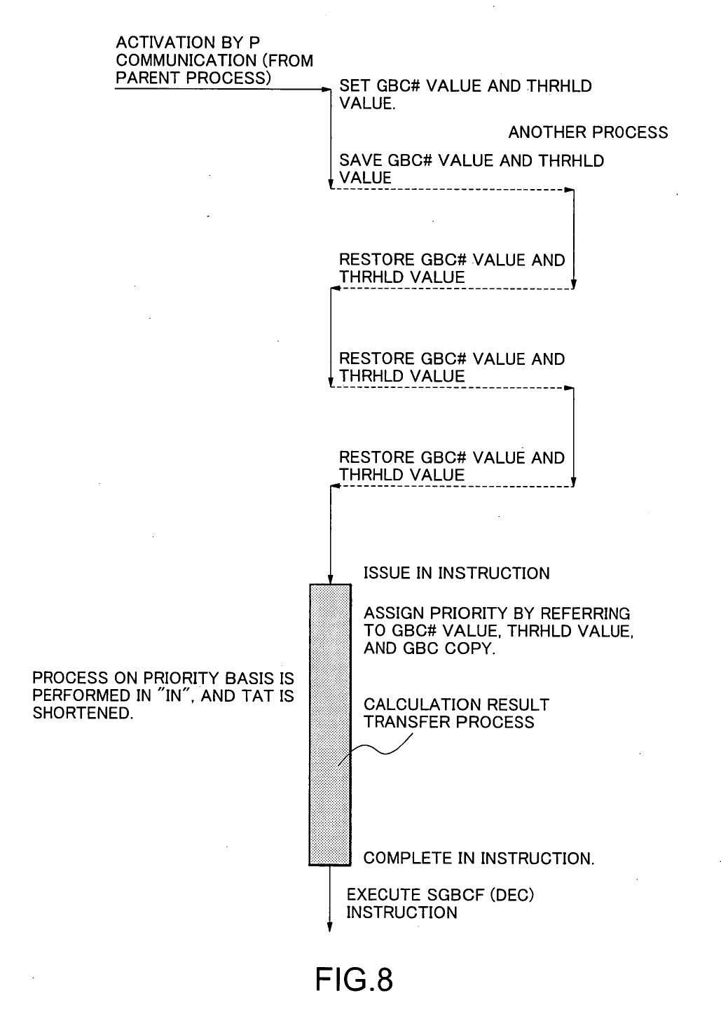

FIG. 8 shows the operation of the child process according to the present embodiment.

The following explanation indicates an example of a plurality of child processes performed in a plurality of nodes. The reference numerals of the important portions in the nodes are explained by referring to the reference numerals of the node 1 shown in FIG. 1. The important portions shown in FIG. 2 are also referred to as necessary.

In FIG. 8, an activate instruction in the P communication is issued from the node of the parent process. At this time, in the instruction of the parent process, the GBC# value is passed as a value identifying the parent process to a child process, and the Thrhld value is passed as a value setting a priority in inter-node transfer to the child process.

Afterwards, each child process saves/restores the values for each process switch. By performing these processes, the GBC# value and the Thrhld value are held also when another process is performed.

Then, immediately before a child process performs a calculation result transfer process, the instruction control unit 113 issues an IN 50 related instruction.

The instruction control unit 113 is assigned the GBC# value and the Thrhld value respectively from the GBC# 111 and the Thrhld 112, and refers to the GBC copy 309 of the child process number replication circuit 300 using the GBC# value.

At this time, when the GBC value is 1, the instruction control unit 113 recognizes that the process is the slowest, and has the child process number replication circuit 300 transfer the GBC# value and the Thrhld value to the IN 50.

Then, the comparator 311 of the child process number replication circuit 300 compares the GBC# value with the Thrhld value. When the GBC# value and the Thrhld value are both set to 1, a priority is assigned. The priority information is stored in the Prio 312, and transmitted to the IN 50 together with the instruction command to the IN 50.

The IN 50 recognizes the information, and controls the TAT in the request with a priority to be processed on a priority basis over the others.

When the slowest child process is executed, the child process issues an SGBCF (des) instruction to terminate the process.

As described above, a priority is assigned to the transfer process from the node in which a computer executing the slowest child process is arranged, and the transfer process in the IN 50 is performed on a priority basis.

Described below in detail is the assignment of a priority to a transfer process.

The assignment of a priority to a transfer process from a node when the parallel job shown in FIG. 6 is performed is explained below. The important portions shown in FIGS. 1 and 2 are referred to as necessary.

The GBC# value and the Thrhld value are held by saving/restoring when a task is switched by the instruction control unit 113, and the values are respectively held in the GBC# 111 and the Thrhld 112 so far as the child process is in the executing state.

The GBC# value and the Thrhld value are assigned to the IN related instruction issued by the central processor unit (hereinafter referred to as a CPU) 11, and transmitted to the RCU 13 through the MMU 12. The child process number replication circuit 300 of the RCU 13 receives an IN related instruction, and holds the GBC# value and the Thrhld value respectively in the Thrhld 301 and the GBC# 303. Then, the GBC value is read from the GBC copy 309 using the GBC# identifying the parent process, and stores the value in the RDR 310.

The GBC value stored in the RDR 310 indicates the number of child processes not completed yet in the same barrier.

When the number is smaller than the Thrhld value or equal to the Thrhld value, it is determined that the child process itself is slower than other processes.

When the Thrhld value is fixed to 1, a priority is assigned only to the slowest child process. The setting of the priority is stored in the Prio 312, and transmitted to the IN 50 together with the instruction command held in the CMD (short for command) 302 to the IN 50.

Thus, a priority is assigned to the transfer process, and transmitted to the IN 50.

Described below is the control of the inter-node transfer process based on the priority set as described above.

FIG. 9 shows the configuration of the circuit of the request arbitration circuit 400 according to the present embodiment.

The request arbitration circuit 400 selects a node based on the priority from the request transmitted from each node to the IN 50.

INUs (input units) 411 and 412 convert a request from each node into a format recognized by the IN 50. The INUs (input units) 411 and 412 also have a buffering function.

OUs (output units) 421 and 422 convert a reply to each node into a format recognized at a node side. The OUs 421 and 422 also have a buffering function.

An OR gate 430 can output OR of priority signals from all nodes.

A priority encoder 431 can transmit the smallest number (INU number) in the request signals from all nodes.

An OR gate 432 can output OR of request signals after a masking process.

A selector 433 can switch a request signal group between a masked request signal group and an unmasked request signal group.

A leading 0 circuit 434 selects a node number for assignment of an arbitration right. The leading 0 circuit 434 generates an arbitration selection node number using the number of 0 from the low order bit of the request signal group data from each node.

A flag 435 can hold the status in which a request is received.

A selector 436 can select an output of a priority encoder 439 when a request with a priority is received.

A register 437 stores a node number selected by arbitration.

A selector 438 selects a command of a request selected by arbitration.

A mask generation circuit 439 prioritizes a request with a subsequent node number to realize an arbitration circuit in a round robin system.

A decoder 440 transmits a request sel signal announcing to the INUs 411 and 412 that a request selected by arbitration has been transmitted.

An IN instruction request control unit 441 processes a request selected by arbitration.

An OR gate 442 outputs OR of request signals from all nodes.

Described below is the operation of a request arbitration circuit of the IN 50 by referring to FIG. 9. The important portion shown in FIG. 1 is referred to as necessary.

In FIG. 9, requests containing a request with a priority are first transmitted from the RCU of each node to the INUs 411 and 412.

A request with a priority is recognized by the OR gate 430, and anode number with which the request is received (hereinafter referred to as a reception node number) is determined by the priority encoder 431.

When a request with a priority is received, a smaller node (node having a smaller INU number) is selected. In this case, the reception node number is stored in the register 437 through the selector 436. Simultaneously, the significant bit information about a request is also stored in the register 435. According to the information, the decoder 440 generates a request sel signal announcing the reception of the request to the INUs 411 and 412.

Thus, a priority is assigned to a transfer process from a node.

Described next is the operation of copying the GBC value in the IN 50 to each node.

FIG. 10 shows the configuration of a child process number monitor circuit 500 according to the present embodiment. The important portion shown in FIG. 1 is referred to as necessary.

The child process number monitor circuit 500 provided in the IN 50 makes the GBC value held in the GBC copy 309 provided in the RCU circuit of each node equal to the GBC value held in the GBC 540 of the IN 50.

INUs 511 and 512 convert a request from a node into a format recognized in the IN 50. The INUs 511 and 512 also have a buffering function.

OUs 521 and 522 convert a reply to a node into a format recognized at the node side. The OUs 521 and 522 also have a buffering function.

A GBC request arbitration circuit 530 can perform an operation of arbitrating GBC access instructions from all nodes. The GBC request arbitration circuit 530 is different from the request arbitration circuit 400.

A V531 is a register for holding a valid bit V (signal indicating that the request is valid) of a GBC access instruction.

A CMD 532 is a register for holding a command of a GBC access instruction.

A GBC# 533 is a register for holding a GBC# value of a GBC access instruction.

A control circuit 534 can control a writing operation to the GBC.

A WE 535 is a register for holding a write enable signal to the GBC.

A decoder 536 generates a valid signal in starting a broadcast to each node.

Upon receipt of an SGBCF (dec) instruction from each node, a decrementer 537 subtracts 1 from GBC data.

A selector 538 can select the data transmitted with a request or the data obtained by subtracting 1 from the GBC data at an instruction from each node.

A WDR 539 is a register for holding write data to a GBC 540.

The GBC 540 is described by referring to FIG. 1, and is a register group for holding a GBC value for synchronization. A GBC value corresponds to each parent process, and the GBC 540 holds a GBC value corresponding to a plurality of parent processes. These plural GBC values are held in the registers of different GBC#.

An RDR 541 is a register for holding read data from the GBC 540.

Described below by referring to FIG. 10 is the operation of making a copy of GBC equal to the GBC 540 in the IN 50. The important portions shown in FIGS. 1 and 2 are referred to as necessary.

First described is the case where an SGBCF (Init) is transmitted from the RCU 13 of the node 1 to the INUs 511 and 512.

When a request is transmitted from a plurality of nodes, the GBC request arbitration circuit 530 selects one of the requests.

The command, GBC#, write data of a selected request are respectively stored in the CMD 532, the GBC# 533, and the WDR 539, and the V531 is turned on (indicating a valid signal).

Furthermore, the WE 535 is turned on, and data is written to the GBC 540.

Next, a valid signal to the OUs 521 and 522 is turned on by the decoder 538 to perform a broadcast to all nodes.

The command, GBC#, and write data (data held in the WDR) are transmitted also to the OUs 521 and 522.

From the OUs 521 and 522, an SGBCF (Init) is broadcast to all nodes.

A similar operation is performed also in the case of an SGBCF (dec). If a subtract instruction is announced in the broadcast, 1 is subtracted from the GBC copy 309 at the RCU 13.

The subtraction of the GBC 540 in the IN 50 is performed by fetching to the WDR 539 the value obtained by subtracting 1 from the old GBC value by the decrementer 537 and writing it after reading the old GBC value temporarily to the RDR 541.

According to the above-mentioned embodiment, a computer job can be divided and the TAT of the parallel job of performing a parallel process by a plurality of child processes can be shortened. As a result, calculation resources can be effectively utilized, and the system performance can be enhanced.

The TAT can be shortened by configuring the processing of the child processes divided for a parallel job by a calculation process and a calculation result transfer process, and shortening the calculation result transfer process from the slowest child process. The calculation result transfer process can be shortened by processing on a priority basis the transfer process from the slowest child process in the IN 50. Additionally, the assigning a priority to a transfer process is performed by transmitting a priority assign instruction from a child process to the IN 50 immediately before the calculation result transfer process when it is detected that the child process is the slowest.

As described above, the transfer process time of the slowest child process can be shortened, and the TAT of the entire parallel job can be shortened.

The operation of the IN 50 of the present invention can be not only realized as hardware, but also realized as software by executing a network control program (application) 100 for executing each of the above-mentioned means by the IN 50 as a computer processing device. The network control program 100 is stored in a magnetic disk, semiconductor memory, and other recording media. Then, it is loaded into the IN 50 from the recording media, and the operation is controlled, thereby realizing each of the above-mentioned functions.

The preferred embodiments of the present invention are described above, but the present invention is not limited to those embodiments, but can be embodied as variations within the scope of the technological concept of the present invention.

While the present invention has been described in connection with certain exemplary embodiments, it is to be understood that the subject matter encompassed by the present invention is not limited to those specific embodiments. On the contrary, it is intended to include all alternatives, modifications, and equivalents as can be included within the spirit and scope of the following claims.

Further, it is the inventor's intent to reform all equivalents of the claimed invention even if the claims are amended during prosecution.

What is claimed is:

1. A parallel processing system, comprising:
a plurality of nodes which are interconnected over an interconnection network;
wherein
the parallel processing system divides a computer job into parallel jobs by a parent process performed by a computer arranged in the nodes, and the parallel jobs are processed by the plurality of child processes using the plurality of computers arranged in the plurality of nodes; and
a transfer process through the interconnection network from a slow child process in the child processes is performed on a basis of priority over other transfer processes.

2. The parallel processing system according to claim 1, wherein
a process performed by the plurality of child processes is configured by a calculation process and a calculation result transfer process, and the calculation result transfer process is performed after the calculation process is performed, and a transfer process from the child process is the calculation result transfer process.

3. The parallel processing system according to claim 2, wherein
the other transfer processes are performed between another parent process than the parent process and a child process of the other parent process.

4. The parallel processing system according to claim 3, wherein
a child process number monitor circuit for monitoring the number of child processes being executed is provided in the interconnection network, and the number of child processes is held in a register provided in the child process number monitor circuit.

5. The parallel processing system according to claim 4, wherein
when the parallel job is processed by a plurality of child processes, information identifying the parent process and value information for setting the priority are transmitted from a parent process to each child process.

6. The parallel processing system according to claim 5, wherein
the information identifying the parent process is address information about the register storing the number of child processes or a process number issued by a computer executing the parent process.

7. The parallel processing system according to claim 6, wherein
when a process of the parallel job is suspended in the child process and another process is performed, the information identifying the parent process and the value information for assigning the priority are saved, and when the other process terminates and the process of the parallel job is resumed, the information and the value information is restored.

8. The parallel processing system according to claim 5, wherein
child process number information required for barrier synchronization is transmitted from the parent process to the child process number monitor circuit, and the number of child processes required for the barrier synchronization in the child process number monitor circuit is written to the register.

9. The parallel processing system according to claim 8 wherein
a child process number replication circuit for holding the number of child processes being executed is provided in the node, and the number of child processes is held in a register in the child process number replication circuit.

10. The parallel processing system according to claim 9, wherein
child process number information required for the barrier synchronization is transmitted from the child process number monitor circuit to the child process number replication circuit of each node in which a plurality of computers for processing a child process executing the parallel job are arranged, and each child process number replication circuit writes the number of child processes required for the barrier synchronization to the register.

11. The parallel processing system according to claim 10, wherein
when the child process terminates, the process transmits to the child process number monitor circuit an instruction to subtract 1 from the number of child processes held in the register provided in the child process number monitor circuit.

12. The parallel processing system according to claim 11, wherein
upon receipt of the instruction to subtract 1 from the number of child processes, the interconnection network transmits to the child process an instruction to subtract 1 from the number of child processes held in a register provided in the child process number replication circuit of a node in which a computer for performing each child process is arranged, and 1 is subtracted from the number of child processes of the register in the child process number replication circuit.

13. The parallel processing system according to claim 12, comprising
a request arbitration circuit for processing on a priority basis a transfer process from a node in which a computer performing a slowest child process is arranged.

14. The parallel processing system according to claim 13, wherein
the slowest child process detects that the number of child processes being performed is 1 by ref erring to a register provided in the child process number replication circuit of a node in which a computer performing the child process is arranged.

15. The parallel processing system according to claim 14, wherein
immediately before starting a calculation result transfer process by the slowest child process, the information identifying the parent process and the information indicating a priority of a transfer process are transmitted from the node to the interconnection network, and the request arbitration circuit processes on a priority basis a transfer process from the node in the request arbitration circuit.

16. An interconnection network, wherein:
the interconnection network is connected to a node in which a computer for performing a parent process for dividing a computer job into parallel jobs is arranged, and a node in which a plurality of computers for performing a child process performing the parallel job are arranged; and
a transfer process from a slowest child process in the child processes is performed on a priority basis over other transfer processes.

17. The interconnection network according to claim 16, wherein
a process performed by the plurality of child processes is configured by a calculation process and a calculation result transfer process, and the calculation result transfer process is performed after the calculation process is performed, and a transfer process from the child process is the calculation result transfer process.

18. The interconnection network according to claim 17, wherein
the other transfer processes are performed between another parent process than the parent process and a child process of the other parent process.

19. The interconnection network according to claim 18, wherein
a child process number monitor circuit for monitoring the number of child processes being executed is provided, and the number of child processes is held in a register provided in the child process number monitor circuit.

20. The interconnection network according to claim 19, wherein
upon receipt of child process number information required for barrier synchronization from a parent process, the child process number monitor circuit writes the number of child processes required for the barrier synchronization to the register.

21. The interconnection network according to claim 20, wherein
the child process number monitor circuit transmits child process number information required for the barrier synchronization from the child process number monitor circuit to a child process number replication circuit, provided in the node, for holding the number of child processes being executed.

22. The interconnection network according to claim 21, wherein
when an instruction to subtract 1 from the number of child processes held in the register provided in the child process number monitor circuit is received from a completed child process, an instruction to subtract 1 from the number of child processes held in the register provided in the child process number replication circuit is transmitted to the plurality of child processes.

23. The interconnection network according to claim 22, comprising
a request arbitration circuit for processing on a priority basis a transfer process from a node in which a computer performing a slowest child process is arranged.

24. The interconnection network according to claim 23, wherein
the request arbitration circuit comprises a circuit for inputting to a selector an OR output of an input signal from a node in which the plurality of computers are arranged and an output of a priority encoder of the input signal.

25. The interconnection network according to claim 24, wherein
when information identifying the parent process and information requesting a priority of a transfer process are received from a node in which a computer performing the slowest child process is arranged, the request arbitration circuit processes a transfer process from the node on a priority basis.

26. A node within a parallel processing system which receives a parallel job as a plurality of child processes divided by a parent process through an interconnection network, and arranges a computer for performing the parallel job, and which processes on a priority basis a transfer process from a slow child process in the child processes over the interconnection network, wherein:
the node comprises a child process number replication circuit for holding the number of child processes being performed; and
the node holds the number of child processes being performed in a register provided in the child process number replication circuit.

27. The node according to claim 26, wherein
when child process number information required for barrier synchronization is received from a child process number monitor circuit which is provided in the interconnection network and monitors the number of child processes being performed, the child process number replication circuit writes the number of child processes to the register.

28. The node according to claim 27, wherein
when an instruction to subtract 1 from the number of child processes written to the register is received from the child process number monitor circuit, 1 is subtracted from the number of child processes of the register.

29. The node according to claim 28, wherein
a slowest child process refers to a register provided in the child process number replication circuit, and detects that the number of child processes being performed is 1.

30. The node according to claim 29, wherein
when information identifying the parent process and value information for assigning a priority are transmitted from the slowest child process to the child process number replication circuit, information identifying the parent process and information requesting a priority of a transfer process are transmitted from the child process number replication circuit to the interconnection network.

31. The node according to claim 30, wherein
the child process number replication circuit comprises a comparator for comparing the value information for assigning a priority with the number of child processes, and a priority is assigned to the transfer process when the value information is larger or equal to the number of child processes.

32. A network control method used over an interconnection network, wherein:
the interconnection network is connected to a node in which a computer performing a parent process which divides a computer job into parallel jobs is arranged, and a plurality of nodes in which a computer performing a plurality of child processes performing the parallel jobs is arranged; and
the control method comprises processing a transfer process from a slow child process in the child processes on a priority basis over other transfer processes.

33. The network control method according to claim 32, wherein
the number of child processes being performed is written to a register.

34. The network control method according to claim 33, wherein
when child process number information required for barrier synchronization is received from a parent process, the number of child processes required for the barrier synchronization is written to the register.

35. The network control method according to claim 34, wherein
the child process number information required for the barrier synchronization is transmitted to a child process number replication circuit which is provided in a node in which the computer performing a child process is arranged, and holds the number of child processes being performed.

36. The network control method according to claim 35, wherein
when an instruction to subtract 1 from a value held in the register is received, an instruction to subtract 1 from the value held in the register provided in the child process number replication circuit is issued to the plurality of child processes.

37. The network control according to claim 36, wherein when information identifying the parent process and information indicating a priority of the transfer process are received from a slowest child process, a transfer process from the node is processed on a priority basis.

38. A computer-readable storage medium recording thereon a program which causes a computer to perform said steps of claim 32.

39. A computer-readable storage medium recording thereon a program which causes a computer to perform said steps of claim 33.

40. A computer-readable storage medium recording thereon a program which causes a computer to perform said steps of claim 34.
